(19) United States
(12) Patent Application Publication
(10) Pub. No.: US 2015/0301722 A1
(43) Pub. Date: Oct. 22, 2015

(54) Method for Controlling an Automatic Distribution or Command Machine and Associated Automatic Distribution or Command Machine

(71) Applicant: THALES, Neuilly Sur Seine (FR)

(72) Inventor: Philippe WARNITZ, Bretigny Sur Orge Cedex (FR)

(73) Assignee: THALES, Neuilly sur Seine (FR)

(21) Appl. No.: 14/646,844

(22) PCT Filed: Nov. 28, 2013
(86) PCT No.: PCT/EP2013/074973

§ 371 Date: May 22, 2015

(30) Foreign Application Priority Data
Nov. 29, 2012 (FR) 12 03231

(51) Int. Cl. G06F 3/0484; G09B 21/00; G06F 3/16; G06F 3/0481; G06F 3/0485

(52) U.S. Cl. CPC G06F 3/04842; G06F 3/0481; G06F 3/0485; G06F 3/167; G09B 21/006

(57) ABSTRACT

The invention relates to a method for controlling an automatic distribution or command machine (10), comprising the steps for emitting a set of sound elements by the automatic machine (10), the sound elements relating to the selectable graphic elements (30, 32, 34, 36, 38) of the graphic interface (12), and for controlling the graphic interface (12) by using at least one control of the plurality of auxiliary control means (18, 20, 22, 24) of the graphic interface (12).

The present invention relates to a method for controlling an automatic distribution or command machine. The invention also relates to an automatic distribution or command machine.

Automatic distribution machines allow automation and acceleration of the distribution of a product or of a service to a user while automatic command machines allow automation and acceleration of the order for a product or a service by a user. For example, providing transport tickets is faster with an automatic distribution machine than through an operator at the counter.

The service proposed by an automatic distribution or command machine having a graphic interface assumes that the user may access the keys of the automatic machine and see the result of pressing on these keys.

Visually impaired or blind users can therefore not benefit from the acceleration of the distribution or of the order provided by the automatic distribution or command machines.

Therefore, there exists a need for an automatic distribution or command machine provided with a graphic interface which is accessible both to normal users and to visually impaired or blind users.

For this purpose, a method for controlling an automatic distribution or command machine is proposed, the automatic machine comprising a graphic interface comprising at least two selectable graphic elements, a plurality of selection means for at least two selectable graphic elements and a plurality of auxiliary means for controlling the graphic interface. The plurality of auxiliary control means of the graphic interface includes a control for scrolling the selection of the selectable graphic elements, and a control for validating the selection of a selectable graphic element. The method comprises steps for emitting a set of sound elements by the automatic machine, the sound elements relating to selectable graphic elements of the graphic interface, and for controlling the graphic interface by using at least one control of the plurality of auxiliary means for controlling the graphic interface.

According to particular embodiments, the method comprises one or several of the following features, taken individually or according to all the technically possible combinations:

the number of auxiliary control means is strictly less than the number of selection means.

the graphic interface is able to operate according a first control mode and a second control mode with emission of sound elements.

the method comprises in the first control mode a step for controlling the graphic interface by pressing on at least one selection means.

the method comprises in the second control mode steps for emitting a set of sound elements by the automatic machine, the sound elements relating to selectable graphic elements of the graphic interface, control of the graphic interface by using at least one control of the plurality of auxiliary control means of the graphic interface.

passing from the first control mode to the second control mode is applied by using an auxiliary means for controlling the plurality of auxiliary control means.

the auxiliary means for controlling the graphic interface are a plurality of keys including a first key, a second key and a third key, the first key and second key being commands for scrolling the selection of the selectable graphic elements and the third key being a validation command of the selection of a selectable graphic element.

passing from the first control mode to the second control mode is applied by pressing on the third key.

the automatic machine comprises a display screen of the graphic interface with a lower edge, an upper edge and two side edges, the three keys being placed side by side at one edge of the screen.

the automatic machine comprises a display screen of the graphic interface with a lower edge, an upper edge and two side edges and the auxiliary control means comprise a key allowing activation of computer tools modifying the appearance of the graphic interface in order to facilitate viewing of the graphic interface, the key being placed beside the lower edge.

the method includes the activation of computer tools modifying the appearance of the graphic interface in order to facilitate the viewing of the graphic interface by using one auxiliary control means of the plurality of auxiliary control means.

the scrolling and validation commands are voice commands emitted by the user.

An automatic distribution or command machine is also proposed, comprising a graphic interface comprising at least two selectable graphic elements, a plurality of means for selecting said at least two selectable graphic elements, a plurality of auxiliary means for controlling the graphic interface. The plurality of auxiliary means for controlling the graphic interface includes a command for scrolling the selection of selectable graphic elements and a command for validating the selection of a selectable graphic element. The automatic machine comprises a controller adapted for applying the control method as described earlier.

Other features and advantages of the invention will become apparent upon reading the detailed description which follows of embodiments of the invention, only given as an example and with reference to the drawings which are:

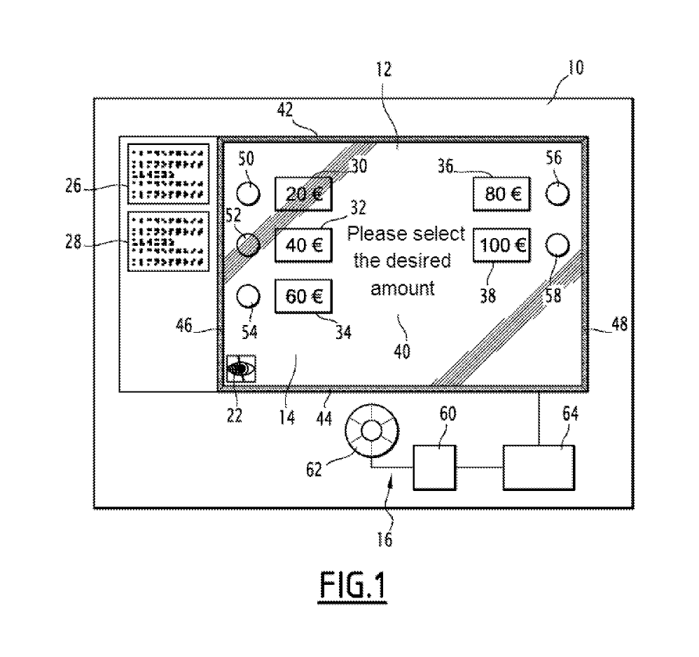

FIG. 1, a schematic view of a portion of an automatic distribution machine according to the invention, the graphic interface being in the first control mode, and

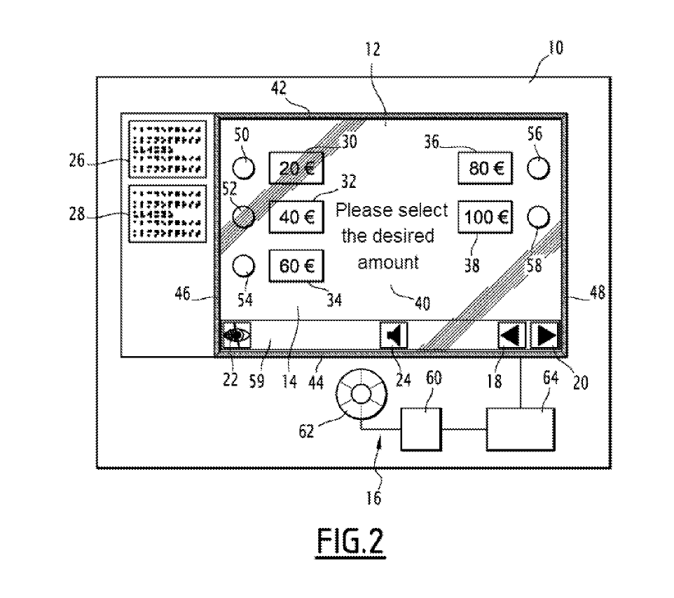

FIG. 2, a schematic view of a portion of the automatic distribution machine of FIG. 1, the graphic interface being in the second control mode.

The automatic distribution machine 10 illustrated in FIGS. 1 and 2 is for example an automatic bank note dispenser of a bank agency.

The automatic machine 10 thus distributes a service in a public space.

Alternatively, the automatic distribution machine 10 is able to be used for selling tickets or transportation tickets.

According to another alternative, the automatic machine 10 is an automatic command machine for example allowing a service to be ordered (notably a menu) in a restaurant.

The automatic machine 10 comprises a graphic interface 12, a screen 14 able to display the current window of the graphic interface 12, a means 16 for producing sound elements, four auxiliary command means as four keys 18, 20, 22 and 24 and two markings 26 and 28.

In computer science, a graphic interface like the graphic interface 12 comprises graphic elements which allow a user to converse with the automatic machine 10 and control it so that the latter carries out the desired actions.

A graphic element is usually illustrated by one of the following objects:
simple display elements notably comprising the following objects:
   a label,
   an icon,
the buttons notably comprising the following objects:
   a push button (also called <<button>>),
   a check box,
   a radio button,
the menus notably comprising the following objects:
   a command menu,
   a circular menu (also called <<pie menu>>),
the containers notably comprising the following objects:
   forms,
   frame,
   tab,
   toolbar,
   scrollbar,
the lists notably comprising the following objects:
   a single choice list,
   a multiple choice list,
the user help fields notably comprising the following objects:
   a text area (also called <<text box>> or <<edit field>>),
   a password area (also called <<password field>>),
   a digital selection area (also called <<spin box>>),
   a cursor (also called <<slider>>),
   a progress bar,
the windows notably comprising the following objects:
   a simple window,
   a modal window,
   a dialog box,
   a floating window (also called <<utility window>>),
hypertext links.

Alternatively, the graphic elements consist of several simpler graphic elements like in the case of a calendar or a combined box also called <<combobox>>.

For the sake of simplicity, in the following, the examples of a graphic interface 12 are limited to push buttons.

In computer science, a graphic interface 12 (often designated by the acronym of GUI for graphical user interface) is a set of man-machine dialog windows allowing the user to control the automatic machine 10 so that the automatic machine 10 carries out the actions desired by the user.

The graphic interface 12 is able to operate according to a first control mode M1 (case of FIG. 1) and a second control mode M2 with emission of sound elements (case of FIG. 2).

Each window of the graphic interface 12 includes display elements and at least two selectable graphic elements. In the following, the selectable graphic elements are simply designated as graphic elements.

The selection of a graphic element allows activation of a functionality of the automatic machine 10 associated with the graphic element.

According to the example of FIG. 1, the current window comprises five graphic elements 30, 32, 34, 36 and 38, the selection of which allows activation of a functionality, and a display element 40.

Each graphic element 30, 32, 34, 36 and 38 appears as a rectangle with a sum in euros written therein. The written sum is 20 euros for the first graphic element 30, 40 euros for the second graphic element 32, 60 euros for the third graphic element 34, 80 euros for the fourth graphic element 36 and 100 euros for the fifth graphic element 38.

By selecting a graphic element 30, 32, 34, 36, 38 the user may ask the automatic machine 10 for the indicated sum in euros in bank notes via the graphic element 30, 32, 34, 36, 38.

The non-selectable element 40 displays an instruction for the user on the screen 14: “Please select the desired amount”.

The screen 14 is a touch screen 14.

The screen 14 has a shape of a rectangle delimited by four edges: an upper edge 42, a lower edge 44 and two side edges 46, 48. The left side edge 46 is the side edge which is on the left of the user looking at the screen 14 and the right side edge 48 is the side edge which is found on the right of the user looking at the screen 14.

The automatic distribution machine 10 comprises five means 50, 52, 54, 56, 58 for selecting graphic elements 30, 32, 34, 36, 38.

Each selection means 50, 52, 54, 56, 58 is respectively associated with a different graphic element 30, 32, 34, 36, 38: the first means 50 for selecting the first graphic element 30, the second means 52 for selecting the second graphic element 32, the third means 54 for selecting the third graphic element 34, the fourth means 56 for selecting the fourth graphic element 36 and the fifth means 58 for selecting the fifth graphic element 38.

According to the example of FIG. 1, each selection means 50, 52, 54, 56, 58 is an area of the touch screen 14 materialized by a circle. By pressing the area delimited by the circle it is possible to select the associated graphic element 30, 32, 34, 36, 38.

Alternatively, the selection means 50, 52, 54, 56, 58 are scrolling fun wheels (often designated as <<scroller>>).

According to another alternative, the selection means 50, 52, 54, 56, 58 are buttons.

According to the example of FIG. 1, the means 16 for producing sound elements comprises a voice synthesis unit 60 and a loudspeaker 62.

The four keys 18, 20, 22, 24 are distinct from the selection means 50, 52, 54, 56, 58.

According to the example of FIG. 2, the keys 18, 20, 22, 24 are areas of the touch screen 14.

According to an alternative, the keys 18, 20, 22, 24 are buttons.

The first key 18 appears as a touch area in which is illustrated an arrow oriented towards the left side edge 46. The first key 18 is only present in the second mode M2.

The second key 20 appears as a touch area in which is illustrated an arrow oriented towards the right side edge 48. The second key 20 is only present in the second mode M2.

The third key 22 appears on the graphic interface 12 as a touch area in which is illustrated a distinctive sign for visually impaired persons. For example, the distinctive sign is a logo with contrasted colors facilitating its examination. The third key 22 is present in both modes M1 and M2.

The fourth key 24 appears on the graphic interface 12 as a touch area in which is illustrated a loudspeaker. The fourth key 24 is only present in the second mode M2.

The four keys 18, 20, 22, 24 are organized according to a navigation banner 59.

The navigation banner 59 is placed adjacent to the lower edge 44 of the screen 14. Thus, the four keys 18, 20, 22, 24 are placed side by side adjacent to the lower edge 44 of the screen 14.

The second key 20 is both placed adjacent to the lower edge 44 of the screen 14 and to the right side edge 48.

The first key 18 is placed adjacent to the second key 20.

The third key 22 is both placed side by side with the lower edge 44 of the screen 14 and with the left side edge 46.

This localization of the keys 18, 20, 22, 24 allows the user to localize the keys 18, 20, 22, 24 by following the edges of the screen 14 with his/her hands.

Both markings 26, 28 are in the form of a sticker.

The first marking 26 is a sticker in Braille explaining the general principle of the second control mode M2.

The second marking 28 is a sticker with touch marks providing assistance to the user for localizing the keys 18, 20, 22, 24.

The automatic machine 10 also includes a controller adapted for applying a method for controlling the automatic distribution machine 10.

The functionalities associated with the four keys 18, 20, 22, 24 are now described.

In the example shown, each key 18, 20, 22, 24 has two functionalities depending on the pressure duration on the key.

For a pressure duration of less than a predetermined threshold, a first functionality is associated with the pressing on the key 18, 20, 22, 24. Such pressing will be described as a <<short press>> in the following of the description.

For a pressure duration above a predetermined threshold, a second functionality is associated with the pressing on the key 18, 20, 22, 24. Such pressing will be described as <<prolonged pressing>> in the following of the description.

A short press on the first key 18 allows selection of the graphic element 30, 32, 34, 36, 38 which follows, according to the scrolling order, the selected graphic element 30, 32, 34, 36, 38. For example, if the third graphic element 34 is selected, with a short press on the first key 18 it is possible to select the fourth graphic element 36.

In the example shown, the set of graphic elements 30, 32, 34, 36, 38 is cyclic. This means that upon shortly pressing on the first key 18 while the selected graphic element is the fifth graphic element 38, the selected graphic element becomes the first graphic element 30.

A short press on the second key 20 allows selection of the graphic element 30, 32, 34, 36, 38 which precedes according to the scrolling order, the graphic element 30, 32, 34, 36, 38. For example, if the third graphic element 34 is selected, shortly pressing on the second key 20 allows selection of the second graphic element 32.

In the example shown, as the set of selectable graphic elements is cyclic, during a short press on the second key 20 while the selected graphic element is the first graphic element 30, the selected graphic element becomes the fifth graphic element 38.

Prolonged pressing on the first key 18 allows direct selection of the first graphic element 30.

Prolonged pressing on the second key 20 allows direct selection of the last graphic element, i.e. the fifth graphic element 38.

Shortly pressing on the third key 22 allows validation of the selection of a graphic element 30, 32, 34, 36, 38.

Prolonged pressing on the third key 22 gives the possibility of passing from the first control mode M1 to the second control mode M2.

A short press on the fourth key 24 allows repetition of an emitted sound.

Prolonged pressing on the fourth key 24 allows activation of computer tools modifying the appearance of the graphic interface 12 in order to facilitate the viewing of the graphic interface 12.

For example, the graphic interface 12 is displayed in an enlarged way (magnifying glass effect). As an illustration, the character font is increased by a factor 2 or 3. Preferably, the enlargement factor as well as the area of the graphic interface 12, on which the enlargement is applied, are configurable.

Alternatively, the contrast of the display of the graphic interface 12 on the touch screen 14 is increased. Such an increase in the contrast is for example obtained by inverting the colors or by applying a filter.

According to another alternative, in the presence of a mouse, it is the display of the pointer associated with the mouse which is modified on the touch screen 14. Notably, the size of the pointer and the contrast of the pointer relatively to the remainder of the graphic interface 12 are increased.

The operation of the automatic dispensing machine 10 is now described for selecting a request for a 40 euro bank note from the automatic machine 10.

The normal user controls the graphic interface 12 in the first control mode M1.

By seeing that the second selection means 52 is associated with the graphic element for requesting 40 euros, the user presses on the second selection means 52.

Selection of the request for 40 euros is obtained.

The operation of the automatic machine 10 for a visually impaired user is different.

The visually impaired user presses shortly on the third key 22, which allows switching to the second control mode M2.

The navigation banner 59 then appears and the user may press on the first key 18, the second key 20 and the fourth key 24.

The second mode M2 does not inhibit the first mode M1. This means that in the second mode M2, the visually impaired user is free to use the selection means 50, 52, 54, 56, 58 or the keys 18, 20, 22, 24. Notably, the user may activate a tool for facilitating his/her viewing of the graphic interface 12 by prolonged pressing on the fourth key 24.

As an illustration, in the following, we assume that the user is sufficiently disabled so as not to be able to use the first control mode M1.

In the second control mode M2, a set of sound elements (either voice or signals) is emitted.

The sound elements give the possibility of making up for the fact that the user does not see or poorly sees the screen 14.

Each sound element corresponds to the reading of a text. In this sense, a sound element is a sound instruction.

This text is relative to the contents of the graphic elements 30, 32, 34, 36, 38 of the graphic interface 12 or to data of the window which is displayed by the screen 14.

Depending on the cases, the text is static or dynamic.

A dynamic text is a text including the reading of a variable. As an example of a dynamic text, mention may be made of the text <<the total price is X euros>> wherein X is a variable depending on the selection of the user.

The voice synthesis unit 60 gives the possibility of transforming a text into a command of the loudspeaker 62 in order to emit an artificial speech. In the example shown, the voice synthesis tool notably gives the possibility of changing the voice of the artificial speech in order to adapt it to various accents of the users, of changing the height, the velocity and the volume of the voice in order to adapt it to ambient noise, include the reading of special characters like monetary signs or punctuations or further include phonetic text in order to take into account specific pronunciations.

Applied to the example shown, upon accessing the window of FIG. 1, a description of the window displayed on the screen 14 is automatically emitted. For example, the text <<Please select the desired amount: 20 euros, 40 euros, 60 euros, 80 euros or 100 euros>> is emitted.

Automatically, the first graphic element 30 is selected. During the selection of a graphic element for a predetermined time, a description of the contents of the graphic elements 30, 32, 34, 36, 38 is emitted. Consequently, the words <<20 euros>> are emitted by the loudspeaker 62.

The predetermined time is selected so that navigation among the graphic elements 30, 32, 34, 36, 38 remains fluid by only emitting the descriptions of the contents of the graphic elements 30, 32, 34, 36, 38 if needed by the user.

Preferably, when this is relevant, as this is the case in this example since the graphic elements 30, 32, 34, 36, 38 are organized according to a single list, the sound elements may be interrupted by the user by pressing on the first key 18 or second key 20. This allows the sound elements to provide assistance to the user without bothering him/her. A restricted use of the sound elements gives the possibility of avoiding excess information.

The user then presses on the first key 18 with short pressing so as to select the graphic element for requesting 40 euros.

Consequently, the words <<40 euros>> are emitted by the loudspeaker 62.

The user then presses shortly on the third key 22.

For example, the loudspeaker 62 then emits the words <<Your request has been actually recorded and is being processed>>.

The second control mode M2 is only active during the time of the operation. Once the bank notes associated with the sum of 40 euros are recovered, the second control mode M2 is no longer active.

Disabling of the second control mode M2 may also be applied by a time-out. After a predetermined period during which no pressing on the four keys 18, 20, 22, 24 has been detected, the second control mode M2 is disabled.

Thus, the automatic dispensing machine 10 is controllable both by a normal user and a visually impaired or blind user. The automatic distribution machine 10 is not discriminating versus the handicap of a user.

The second control mode M2 is a simplified control mode as compared with the first control mode M1 since the number of keys is less than the number of selection means and in a centralized way allows access to the whole of the graphic interface 12. This simplification makes this control mode well adapted for a visually impaired or blind user.

Further, the arrangement of the keys 18, 20, 22, 24 allows positioning of the left thumb of the user for validating and of the right thumb for selection. This is usually better adapted for a visually impaired or blind user.

The presence of oral instructions allows the user to be aware of the contents of the graphic interface 12 without reading it.

The proposed control method is independent of the operation in a normal mode of the graphic interface 12. Notably, the complexity of the graphic interface 12 and the number of selection means 50, 52, 54, 56, 58 are not taken into account. Consequently, the control method may be applied on any type of automatic machine 10 by simply modifying the software package associated with the graphic interface 12. The selection means 50, 52, 54, 56, 58 remain unchanged.

According to an alternative, the automatic machine 10 only includes two keys instead of four keys 18, 20, 22, 24, one of the two keys being used for selecting the desired graphic element by scrolling and the other key being used for confirming validation of the selection.

Alternatively, instead of a control by means of the four keys 18, 20, 22, 24, in the second control mode M2, the control of the graphic interface 12 is ensured by means of a joystick.

According to another alternative, instead of a control by means of the four keys 18, 20, 22, 24, in the second control mode M2, the control of the graphic interface 12 is ensured by receiving voice commands emitted by the user of the automatic distribution machine 10.

This reception is applied by means of a microphone receiving the instructions from the blind user.

For scrolling the selectable graphic elements 30, 32, 34, 36, 38, the blind user uses <<preceding>> and <<next>> voice commands. For validating the selection of a graphic element 30, 32, 34, 36, 38, the blind user may use the voice command <<validation>>.

Thus, by means of three voice commands, the blind user is capable of using the graphic interface 12 of the automatic distribution machine 10.

Alternatively, the second mode M2 is constantly present which avoids having to switch between the first and second modes M1 and M2.

According to still another alternative, the method is an executable separate from the graphic interface 12 or a compilable library with the graphic interface 12.

1. A method for controlling an automatic distribution or command machine, the automatic machine having a plurality of functionalities and comprising:
a graphic interface comprising at least two selectable graphic elements, the selection of a graphic elements activating a functionality of the automatic machine associated with the graphic element;
a plurality of selection means for at least two selectable graphic elements;
a plurality of auxiliary means for controlling the graphic interface including:
a command for scrolling the selection of selectable graphic elements, and
a command for validating the selection of one selectable graphic element;
the method comprising the steps:
emitting a set of sound elements by the automatic machine, the sound elements relating to the selectable graphic elements of the graphic interface,
controlling the graphic interface by using at least one command of the plurality of auxiliary control means of the graphic interface,
the emitting of a set of sound elements by the automatic machine being applied after selecting one of the selectable graphic elements of the graphic interface for a predetermined time, and
the method further including the steps:
selecting a selectable graphic element by using a validation command and
emitting a sound elements relating to the selected graphic element.

2. The method according to claim 1, wherein the graphic interface is able to operate according to a first control mode is able to operate according to a first control mode and to a second control mode with emitting of sound elements,
the method comprising in the first control mode the steps:
controlling the graphic interface by pressing on at least one selection means;
the method comprising in the second control mode the steps:
emitting a set of sound elements by the automatic machine, the sound elements relating to the selectable graphic elements of the graphic interface, and
controlling the graphic interface by using at least one command of a plurality de auxiliary means for controlling the graphic interface; and
passing from the first control mode to the second control mode being applied by using an auxiliary control means of the plurality of auxiliary control means.

3. The method according to claim 2, wherein passing from the first control mode to the second control mode does not inhibit the first control mode.

4-5. (canceled)

6. The method according to claim 1, wherein the auxiliary means for controlling the graphic interface are a plurality of keys including a first key, a second key and a third key, the first key and second key being commands for scrolling the selection of the selectable graphic elements and the third key being a command for validating the selection of a selectable graphic element.

7. The method according to claim 6, wherein the validation command is a voice command emitted by the user.

8. The method according to claim 6, wherein passing from the first control mode to the second control mode is applied by pressing on the third key.

9. The method according to claim 6, wherein the automatic machine comprises a screen for displaying the graphic interface with a lower edge, an upper edge and two side edges, the three keys being a placed adjacent to an edge of the screen.

10. The method according to claim 1, wherein the automatic machine comprises a screen for displaying the graphic interface with a lower edge, an upper edge and two side edges and the auxiliary control means comprise a key allowing activation of computer tools modifying the appearance of the graphic interface in order to facilitate viewing of the graphic interface, the key being adjacent to the lower edge.

11. The method according to claim 1, wherein the method includes the activation of computer tools modifying the appearance of the graphic interface in order to facilitate viewing of the graphic interface by using an auxiliary control means of the plurality of auxiliary control means.

12. The method according to claim 1, wherein the the scrolling and validation commands are voice commands emitted by the user.

13. The method according to claim 1, wherein the number of auxiliary control means is strictly less than the number of selection means.

14. An automatic distribution or command machine having a plurality of functionalities and comprising:
a graphic interface comprising at least two selectable graphic elements, the selection of a graphic elements activating a functionality of the automatic machine, associated with the graphic element;
a plurality of means for selecting at least two selectable graphic elements;
a plurality of auxiliary means for controlling the graphic interface including:
a command for scrolling the selection of the selectable graphic elements, and
a command for validating the selection of a selectable graphic element; and
a controller adapted to carrying out the method for controlling according claim 1.
